(19) United States
(12) Patent Application Publication
(10) Pub. No.: US 2008/0192017 A1
(43) Pub. Date: Aug. 14, 2008

(54) Automatic Projection Calibration

(75) Inventors: Peter W. Hildebrandt, Duluth, GA (US); Scott Wilson, Kailua-Kona, HI (US); James D. Watson, Duluth, GA (US); Brent W. Anderson, Portland, OR (US); Neal A. Hofmann, Atlanta, GA (US); Brand C. Kvavle, Tigard, OR (US); Jeffrey P. Hughes, Sugar Hill, GA (US); Joseph Hubert, Portland, OR (US)

Correspondence Address: TROUTMAN SANDERS LLP, 600 PEACHTREE STREET , NE, ATLANTA, GA, 30308, US

(73) Assignee: Polyvision Corporation, Suwannee, GA (US)

(21) Appl. No.: 11/911,185

(22) PCT Filed: Apr. 11, 2005
(86) PCT No.: PCT/US05/12118

§ 371 Date: Oct. 10, 2007

(51) Int. Cl. G09G 5/10; G09G 3/36

(52) U.S. Cl. 345/173

(57) ABSTRACT

The present invention is a whiteboard method and system (100) having automated projection calibration that does not require user interaction. The method and system are accomplished by placing sensors (302) beneath a target surface and projecting a projected pattern to discover a geometric correspondence between the target surface and the projecting device. Optical sensors (32) are preferably employed to sense the presence of the projected pattern on the whiteboard. The input data is used with a mapping function or translation matrix for converting whiteboard coordinates to screen coordinates, which are then used for mapping the coordinates to a cursor position. When the geometry of the whiteboard surface is known, and the locations of the optical sensors within this geometry are known, the information about which projector pixels illuminate which sensor can be used to calibrate the projecting device with respect to the whiteboard.

### BACKGROUND

1. Field of the Invention

This invention relates generally to whiteboard calibration systems, and more particularly to a method of automatically aligning a display image on a whiteboard by calibrating known positions on the surface of the whiteboard with a projected pattern.

2. Description of Related Art

Tracking systems are used so a presenter can control a computer from a remote location. For example, when using an interactive whiteboard system, the presenter can control the computer from the whiteboard. Properly calibrated tracking ensures commands of the board are properly interpreted by the computer.

An electronic whiteboard can include a familiar dry erase whiteboard, primarily used for meetings and presentations, which saves indicia written on its surface to a computer connected to or embedded in the whiteboard. In the prior art forms, the user writes on the electronic whiteboard surface using dry erase markers, while in others, the user uses a non-marking stylus. The manner of writing on both forms will be referred to collectively as “writes” or “writing.” Regardless of the type of instrument used to write on the surface, the electronic whiteboard saves indicia written on its surface in electronic format to a computer via a software program. The user can then print, fax, e-mail, and edit the meeting notes that were written on the whiteboard surface. Just as electronic whiteboards can detect writing on the whiteboard surface, electronic whiteboards also can sense the location of a touch on the whiteboard surface.

Electronic whiteboard surfaces typically incorporate a touch sensitive screen. Touch screens are widely used to present a user with an intuitive pointing interface. For example, touch screens are used in automatic teller machines, scientific and industrial control devices, public kiosks, and hand held computing devices, to name but a few common touch applications. In order to operate, touch screens can use various technologies, including resistive, capacitive, acoustic, infrared, and the like. In most touch screen applications, the touch sensitive surface is permanently mounted on a display device such as a cathode ray tube (CRT), or a liquid crystal display (LCD). Receivers are coupled to processes that can then take appropriate actions in response to the touching and the currently displayed image.

Electronic whiteboards provide many benefits to users during meetings and presentations. By saving the indicia written on the whiteboard to a computer so that the writings can be printed out or e-mailed to others, the whiteboard provides an accurate record of the meeting or presentation. This feature of whiteboards allows those present to focus on the meeting, not on note taking. Also, because the electronic whiteboard can sense the location of a touch, the connected computer can be controlled by touching buttons belonging to the graphical user interface in the display image. This allows the user to control the flow of the meeting without leaving the front of the room.

Conventional electronic whiteboards, however, do have disadvantages. Usually, they are complicated to use. This disadvantage prevents novice users from enjoying the benefits such technology offers for meetings and presentations. One of the complications present in using electronic whiteboards is the calibration of the whiteboard.

Calibration is necessary so the display image is properly aligned on the surface of the whiteboard. In essence, the calibration process ensures that actions at the whiteboard are successfully tracked, and interpreted by the computer. The computer, projector, and whiteboard should be in sync, such that the computer can properly relate touch positions on the whiteboard to locations on the computer monitor, and thus, properly correlate touch inputs detected on the surface of the electronic whiteboard with points on the display image.

Typically, calibrating an electronic whiteboard involves the user operating at the computer, rather than at the electronic whiteboard, to first start a calibration. The user must walk away from the presentation, and the focus of the audience, and approach the computer. Then, after the user initiates a calibration sequence at the computer, the user then walks back to the whiteboard to perform a calibration action at the whiteboard to both enable and complete the calibration process. It is well understood that such two-location calibration, first at the computer, then at the whiteboard, can be very distracting, and take away from the flow of the presentation.

Conventional whiteboard calibration can include placing the system into the projection mode from the computer, then having the presenter approach the board and touch, usually, four points (or more) of an image on the display area on the whiteboard. The system relates the touches of the user to the projected image so the system is properly aligned as between the computer, projector and board.

This complicated procedure scares novice technology users away from electronic whiteboard technology, and overcomplicates the set-up process for those who do use electronic whiteboards. It would be beneficial to automatically calibrate an electronic whiteboard.

Automated calibration systems exist in other fields. For example, image registration systems for registering multiple images on a screen (systems for coordinating color overlays of multiple CRT images, for example) are well known. U.S. Pat. No. 4,085,425 generally discusses the control of size and location of a projected cathode-ray image. U.S. Pat. No. 4,683,467 discloses an automated alignment scheme for the then-problem of aligning multiple images of cathode ray tubes, wherein, each image has a different color, to form a single image having the color combination of both CRT images.

U.S. Pat. No. 4,684,996 discloses an automated alignment system that relies on timing. A change in projector alignment shifts the beam time of arrival at a sensor. A processor compares the time of arrival of the projector beam at each sensor with a look-up table and, from this comparison, determines the beam control corrections required to fix alignment. U.S. Pat. No. 6,707,444 discloses a projector and camera arrangement with shared optics. U.S. Patent Publications 2003/0030757, 2003/0076450 and 2003/0156229 disclose calibration controls for projection televisions.

Thus, while it appears that various forms of automated calibration exist in some fields, it is not known to automatically calibrate an electronic whiteboard system. It would be beneficial to both initiate calibration at a location distant the computer (for example, by remote control, or just turning on the lights of a room) and be able to complete the calibration process without user interaction (eliminating the presenter approaching the board and touching projected cross-hairs, or other projected features, to complete the calibration process).

Therefore, it can be seen that there is a need in the art for an improved calibration method for whiteboards.

### SUMMARY OF THE INVENTION

Briefly described the present invention is a method and system for calibrating a tracking system. The tracking system generally includes a computer and a presentation surface distant the computer. The tracking system syncs actions at the presentation surface with the computer.

The tracking system of the present invention includes a touch screen, being the presentation surface, and at least one projecting device capable of projecting a display image of the computer to the touch screen. A preferred embodiment of the present invention comprises an electronic whiteboard as the touch screen. In this preferred embodiment, the projecting device projects the display image upon the whiteboard. It is a preferred object of the present invention to automatically calibrate the display image on the touch screen, so the tracking of actions at the whiteboard (typically writing and eraser actions) is properly interpreted by the computer. The invention preferably both enables initiation of the calibration distant the computer, and the completion of the calibration process, without user interaction.

In prior art calibration systems, the user needs to first tell the system to begin calibration, usually with the push of a computer key at the computer. In these conventional systems, the user also needs to step in a second time during the calibration process, positively interceding during the calibration, to have the system complete the calibration process. This second action usually includes having the user approach the board, touching the whiteboard where instructed.

The present calibration system eliminates a two step, manual approach of calibration, thus making the process automatic. The present invention is a whiteboard system having automated calibration of a display image that can be initiated away from the computer, and does not require user interaction to complete or interfere in the process. Indeed, the presenter need not consciously initiate calibration of the system, as the initiation of calibration can occur automatically upon detecting a passive action of the presenter. For example, while the presenter can begin calibration with a remote control, the present system can identify passive actions like turning on the lights, or a person walking by the board, as indications to begin the calibration process.

The present invention calibrates the display image on the whiteboard utilizing a projected pattern, or gradient thereof, to aid in automatically determining proper alignment. Optical sensors at known locations can be employed in the whiteboard to sense a characteristic of a projected pattern, if the projected pattern is pattern of light, for example a combination of light and dark pattern, on the whiteboard, the characteristic would be the intensity of light. Data from the sensors relating to the projected pattern is used with a mapping function or a translation matrix for converting whiteboard coordinates to screen coordinates, which are then used for mapping the coordinates to a cursor position. The data from a sensor, “sensed data”, can include a measure of intensity or color of the light projected on a sensor. This is distinguished from camera-based systems that measure light reflected from the surface indirectly, which leads to additional complications.

The sensors are located preferably behind the sheets of the touch sensitive surface of the whiteboard, thus hidden from view by the presenter and audience, and the projected pattern does not need to overlap the edges of the whiteboard, as would be required if the sensors were placed beyond the perimeter of the touch sensitive surface.

Individual discrete sensors measure the intensity of the projected pattern at each location directly. Using one or more types of projections, the system can determine which pixel in the display image is illuminating which sensor location.

When the geometry of the whiteboard surface is known, and the locations of the optical sensors within this geometry are known, the information about which projector pixel illuminates which sensor can be used by the projecting device to properly calibrate the display image upon the whiteboard.

In one embodiment of the present invention, the sensors are light emitting diodes (LEDs), or photodiodes, enabling, in essence, the process of calibration to be reversed. That is, while in one mode the sensors are designed to receive characteristics of the projected pattern, which is measured and provides the proper alignment data; in another mode, the process can be essentially reversed, such that the LEDs give off light, such that the sensor locations otherwise hidden from view in the electronic whiteboard can easily be seen. This allows the locations of the sensors to be quickly and easily known.

In another embodiment, the geometry of the whiteboard and the space provided for a sensor to be located behind the sheets leads to the design of a sensor mechanism that is essentially a sheared fiber optic cable, with a receiving (sensor) end of the optical fiber having a beneficial collection geometry, for example, having an angle of shear that provides a normal surface to collect an intensity of radiation from the projected pattern. The optical fiber need not be so sheared, but simply cut at the receiving end.

Alternatively, the receiving end of the optical fiber can have other collection assemblies, for example, it can be in optical communication with a prism or other optical turning device, wherein the projected pattern intensities are transmitted from the prism to the fiber optics. The other end of the fiber is connected to a photodiode or photo detector to detect the light intensity on the end of the fiber.

The present invention preferably can correct many calibration and alignment issues, including projector position and rotation, image size, pincushioning, and keystone distortion automatically, preferably with no step requiring user interaction.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE FIGURES

FIG. 1 depicts a system diagram illustrating a preferred embodiment of the present invention.

FIG. 2 depicts a system diagram illustrating a preferred embodiment of the present invention.

FIG. 3A depicts a layered illustration of an electronic whiteboard according to one embodiment of the present invention.

FIG. 3B depicts a side view layered illustration of the electronic whiteboard.

FIG. 4 is an illustration of a system for calibrating a projecting device to a planar display surface.

FIG. 5 depicts a layout of the sensor assembly positioned within a whiteboard of the present invention.

FIG. 6 depicts a preferred embodiment of the layout of the sensor assembly positioned within the electronic whiteboard.

FIG. 7 illustrates an embodiment of the present invention having a single sensor solution.

FIG. 8 illustrates a preferred set of calibration patterns according to the present invention.

FIG. 9 depicts a preferred connection from sensors routing back to the projecting device.

FIG. 10 is a flow diagram illustrating a method of calibrating the electronic whiteboard.

FIG. 11 is an embodiment of a method of calibrating the electronic whiteboard depicted in a flow diagram.

### DETAILED DESCRIPTION OF THE FIGURES

The present invention is a method and system of automatically calibrating a tracking system calibration that does not require the user of the system to step in during the sequence of calibration to complete the calibration process. The tracking system comprises a touch screen and at least one projecting device. Preferably, the touch screen is an electronic whiteboard. While the detailed description discloses an electronic whiteboard as the touch screen, one of skill in the art will appreciate that the electronic whiteboard can include various types of presentation surfaces. To accomplish the calibration process, the implementation of a number of sensors within or on the whiteboard eliminates the prior art need of a user approaching the board, then touching the board at cross-hairs or other projected features where instructed, to calibrate the whiteboard. As used herein, the techniques of calibration, alignment, and orientation will be referred to collectively as “calibration.”

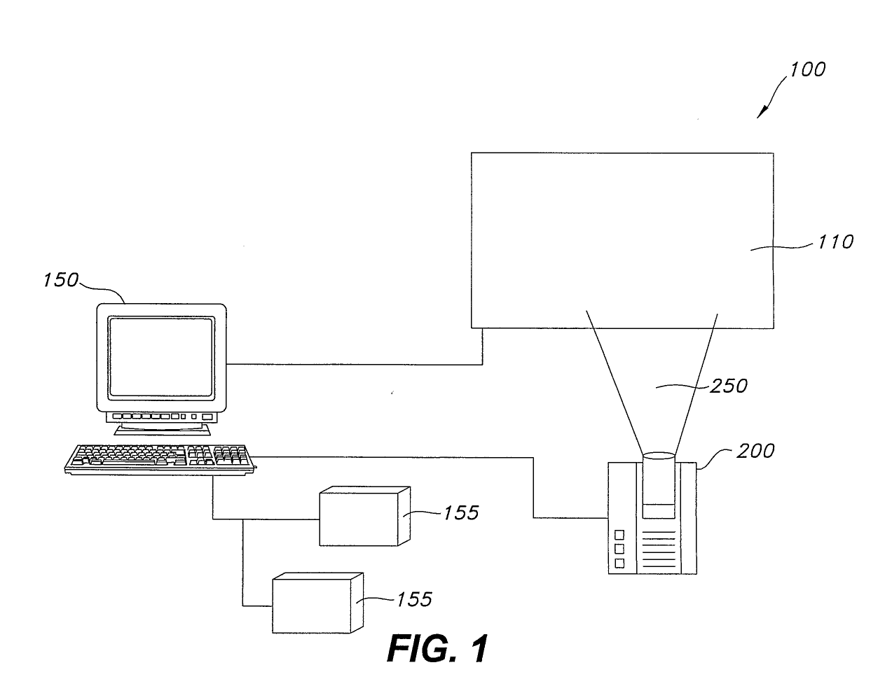

Referring to the drawings, wherein like reference numerals represent similar elements throughout the several figures, and more specifically, referring to the present application, FIG. 1 is provided as a simplified system diagram illustrating an exemplary environment of the present invention. Although an exemplary environment is shown as embodied within a personal computer and an electronic whiteboard, those skilled in the art will appreciate that the present invention can be embodied in a display arrangement involving a processor, not necessarily a computer, a location sensitive surface, among others, and a projection of a display on the location sensitive surface requiring calibration.

Electronic whiteboards 100 acceptable in accordance with a preferred embodiments of the present invention include products from vendors such as SMART TECHNOLOGIES, EGAN VISUALS, Prometheon, Hitachi Software, Virtual Ink, eBEAM, and 3M, among others. The electronic whiteboard 100 could also include, but is not limited to, laser-triangulation touch resistive or capacitive films, radio sensitive surface, infrared array, or ultrasonic frequency sensitive device.

As depicted in FIG. 1, electronic whiteboard 100 is in communication with a processing device 150, which can be a personal computer 150. Processing device 150 in some embodiments need not be a stand-alone element of the present invention, but can be a part of other elements of the system. For example, the processing device 150 can be an integrated component of the electronic whiteboard 100, or the processing device 150 can be an external component, like a computer.

The linkages of the communication between the processing device 150 and the electronic whiteboard 100 are depicted as hard-wire links, i.e. this connection can be employed through a wired connection. Nevertheless, it will be understood that this communication is not limited to a metallic or fiber optic wired protocol. The linkages can be via a wireless connection by a wireless data protocol (e.g. Bluetooth, IEEE 802.11b communication, etc.). Furthermore, the connection can be made via a network connecting the electronic whiteboard 100, the personal computer 150. Additionally, while one or more peripherals 155 (e.g. a printer, scanner) can also be connected, the whiteboard 100 need not include any peripherals 155.

In an exemplary embodiment, the system requirements for the personal computer 150 to operate the present invention include the capability to output video data or display images to a projecting device 200. Furthermore, the software requirements of the personal computer 150 include software to convert electronic whiteboard coordinates to screen coordinates, such as Webster Software, SMART Notebook, and Walk-and-Talk.

In addition, in an exemplary embodiment for the present invention, the peripheral device 155 can be a printer, which is in communication with the personal computer 150 and may be used to print images detected on the electronic whiteboard 100. In yet another embodiment, the peripheral 155 can be a scanner, which is in communication with the personal computer 150 and can be used to scan images to be sent to the personal computer 150 and then displayed on the electronic whiteboard 100.

Electronic whiteboards 100 can receive input from a user in a variety of ways. For example, electronic whiteboards 100 of the present invention can incorporate capacitance technology and receive input from a user via an electrically conductive stylus. The stylus can be a writing implement, including a finger. An exemplary stylus can transmit a signal to electronic whiteboard 100 indicating the location of the stylus in relation to a surface of electronic whiteboard 100. The stylus can also transmit other information to electronic whiteboard 100 including but not limited to pen color, draw or erase mode, line width, font or other formatting information.

In another embodiment, electronic whiteboard 100 can be touch sensitive or pressure sensitive. Touch sensitive or pressure sensitive as used herein means having the capability to convert a physical contact into an electrical signal or input. Touch sensitive electronic whiteboards can incorporate resistive membrane technology. See for example U.S. Pat. No. 5,790,114 to Geaghan et al. describing resistive membrane electronic whiteboards, and which patent is incorporated herein in its entirety.

In one embodiment, electronic whiteboard 100 has two conductive sheets—a top sheet and a bottom sheet—physically separated from one another, for example by tension, such that the two sheets contact each other in response to a touch or physical pressure. The sheets are made of a conductive material or can be coated with a conductive material such as a conductive film, and can be deformable. Touching, writing, or other application of pressure on the surface of the conductive sheets causes contact between the two conductive sheets resulting in a detectable change in voltage or resistance. The sheets can act as resistance dividers and a voltage gradient can be created by applying different voltages at the edges of a sheet. The change in voltage or resistance can then be correlated to a location value, for example a Cartesian coordinate set. Coordinate data, for example (x,y) pairs or their equivalent, can be transmitted to the personal computer 150 in compatible data packets, for processing, manipulating, editing, or storing.

Other embodiments for an electronic whiteboard 100 include laser-tracking, electromagnetic, infrared, camera-based systems, and so forth. These systems detect the presence of ink markings or a pointer or stylus device across a two-dimensional surface, which may be enabled for erasure of marks made with a dry-erase maker, but do not have to be.

Conventional dry-erase markers are typically used to write on a surface 110 of electronic whiteboard 100, but any erasable or removable ink, pigment, or coloring can be used to physically mark a surface of electronic whiteboard 100. The physical markings on electronic whiteboard 100 can be removed using conventional methods including an eraser, towel, tissue, hand, or other object that physically removes the markings from the surface of electronic whiteboard 100.

The whiteboard system further comprises a projecting device 200, available from INFOCUS SYSTEMS, 3M, TOSHIBA, and EPSON, among others, in communication with the personal computer 150. An image from the computer 150 can be transmitted to the projecting device 200, and projecting upon the whiteboard as a display image 250. The projecting device 200 projects the display image 250 upon the surface 110 of the electronic whiteboard 100.

The projecting device 200 can be operatively connected to personal computer 150, whiteboard 100, or both. The projecting device 200 can be a conventional projector for projecting a graphical user interface onto the surface 110 of the electronic whiteboard 100. Projecting device 200 can adjust for image distortions including keystoning and other optical problems, for example, optical problems arising from the alignment of the display image 250 on surface 110. Alternatively, the personal computer 150 can adjust for image or alignment problems. The presenter can also adjust the system to compensate for image problems including keystoning.

In at least some embodiments, the personal computer 150 can be used to provide the display image 250 to the projecting device 200. For instance, a GUI (graphical user interface), spreadsheet image, or motion picture, among others, which can be displayed on the monitor of the personal computer 150, can be displayed by the projecting device 200 upon the surface 110 of the whiteboard 100.

Another embodiment of the present invention includes the use of a plasma display or rear-projection system with a coordinate-detecting system, such as a touch-sensitive surface, capacitive, camera-based, laser-tracking, electromagnetic, or other systems, whereby a stylus can be tracked on the surface and the video source is provided by the personal computer 150.

The electronic whiteboard 100 can also include a remote control device (not shown) in communication with the electronic whiteboard 100, or a component thereof for activating the present invention. For example, the remote control device can be in communication with electronic whiteboard 100, personal computer 150, projecting device 200, or a combination thereof. Communication between the remote control device and another component of the whiteboard 100 can be by electromagnetic technology, including, but not limited to, infrared or laser technology. Additionally, communication between the remote control device and the electronic whiteboard 100 can be by conventional wireless, radio, or satellite technology.

In an exemplary embodiment, the electronic whiteboard 100 is generally mounted to a vertical wall support surface. The projecting device 200 is positioned with respect to the whiteboard surface 110, such that display images 250 projected by the projecting device 200 are directed upon the whiteboard surface 110. The projecting device 200 can be mounted to a ceiling surface within a room that includes the whiteboard 100. In the alternative, the projecting device 200 can be positioned on a table or cart in front of the whiteboard surface 110. Although not illustrated, in some embodiments, the projecting device 200 can be positioned behind the whiteboard surface 110 to have the display image 250 reflected upon the rear of the whiteboard surface 110; this causes the light being transmitted through the surface and to be visible from the front of the surface 110. The personal computer 150 and the peripheral 155 are generally located within the same room as, or at least proximate to, the whiteboard 100, so that each of these components is easily employed during the use of the whiteboard 100, and further easing the use of the whiteboard 100. It is to be noted that in some embodiments the computer 150 and the peripheral 155 need not be proximate to the whiteboard 100.

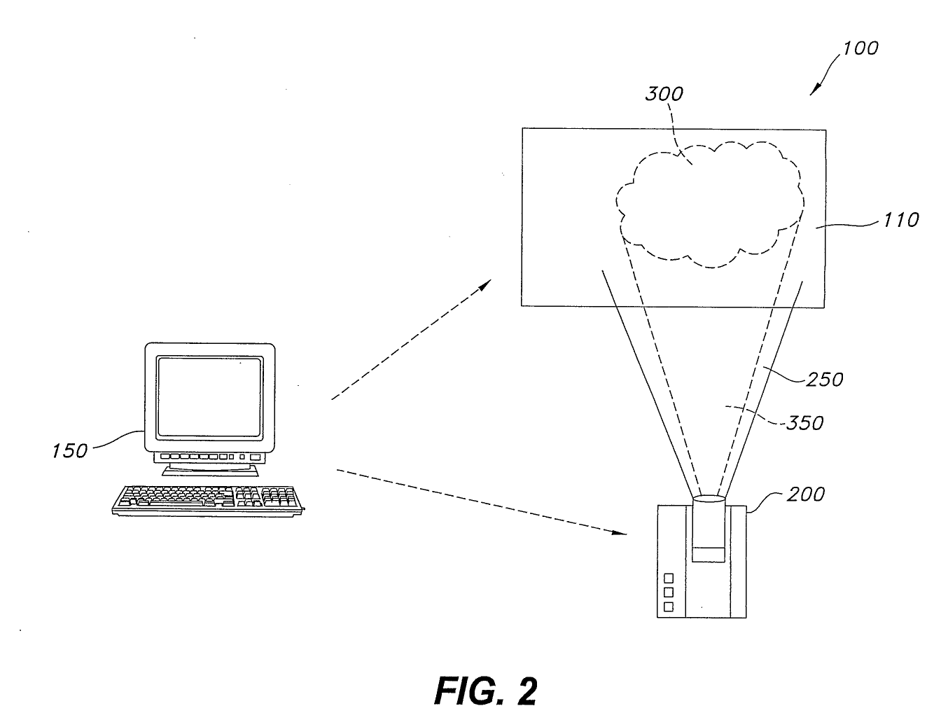

FIG. 2 illustrates an embodiment of the present invention, which provides the present system with automatic calibration. Upon calibration initiation, the projecting device 200 projects a projected pattern 350 to a sensor assembly 300 of the surface 110 of the whiteboard 100. Sensors of the sensor assembly 300 located at known locations in the whiteboard 100 receive characteristics of the projected pattern 350. Data from the sensors regarding the projected pattern 350 is used with a mapping function or translation matrix to calibrate the display image 250 to the whiteboard 100.

For instance, the projected pattern 350 can include an infra-red pattern, light and dark light patterns, an audio pattern, or gradient thereof. Based on information regarding the projected pattern 350 obtained by the sensor assembly 300, calibration can be achieved, and the display image 250 properly calibrated upon the whiteboard.

To automatically initiate calibration, the sensor assembly 300 of the present invention can detect whether the projecting device 200 is on. Upon determining that the projecting device 200 is on, the sensor assembly 300 can communicate with the system to begin the calibration process. The sensor assembly 300, further, can be designed with the ability to detect people in the room (e.g. a person walks by the surface of the whiteboard), or a change in ambient light (e.g. the room light being turned on/off) and use such detection methods to initiate calibration. Once the sensor assembly 300 determines one of these, or similar events, the calibration sequence can be started

While FIG. 2 shows the projected pattern 350 within the cone of display image 250, it will be understood this is for illustrative purposes only. The projected pattern 350 and display image 250 can have unrelated angles of projection, be displayed at the same time in some instances, or more commonly, the projected pattern 350 is first displayed upon the sensor assembly 300, and calibration completed, before the display image 250 is displayed upon the whiteboard 100. Further, the display image 250 and the projected pattern 350 can be the same, wherein enough information about the display image 250 is known by the system that the display image 250 can be used to calibrate the system. Alternatively, a second projecting device 200 can be included to project the projected pattern 350, such that the display image 250 and projected pattern 350 are projected by different devices, but the spatial offset between the devices is known so as to properly calibrate the system.

The sensor assembly 300 can be housed in or upon the electronic whiteboard 100. As such, the projected pattern 350 can be projected directly upon the whiteboard surface 110 of the whiteboard 100 to be sensed. Alternatively, the sensor assembly 300 can be distant the whiteboard 100.

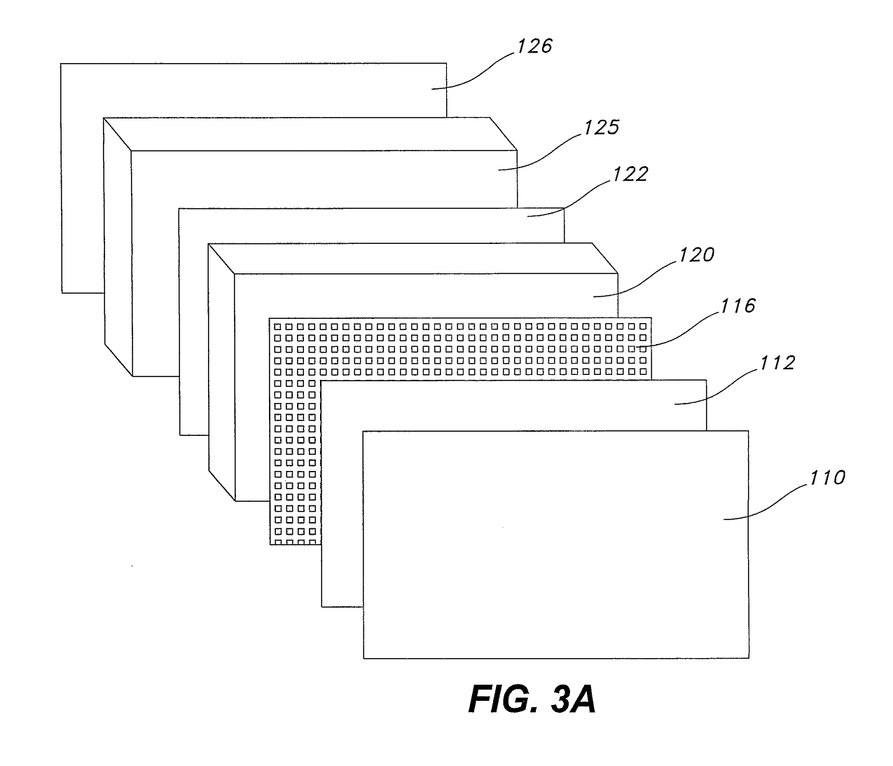

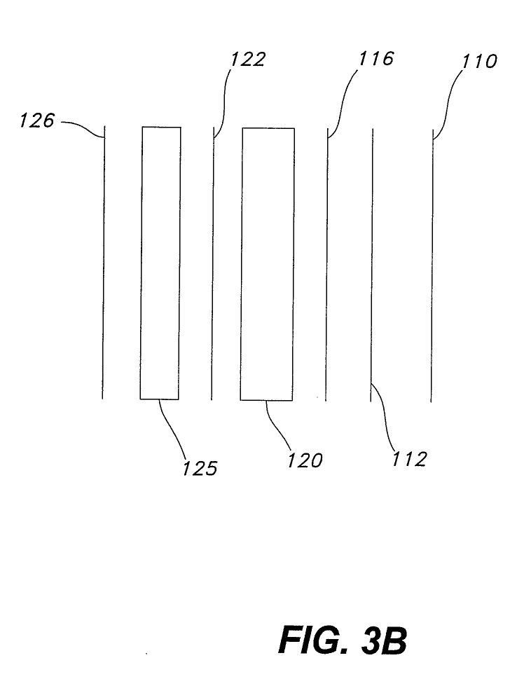

As illustrated in FIGS. 3A and 3B, the electronic whiteboard 100 comprises a multi-layered whiteboard. The electronic whiteboard 100 comprises a location sensitive surface 110, a top sheet 112, and a bottom sheet 116. In an alternative embodiment, the surface 110 can be the top sheet 112. The bottom sheet 116 can be in communication with a foam cushion 120, followed by a metal backer 122, a rigid foam layer 125, and finally a second metal backing 126. Examples of conventional location sensitive surfaces 110 include, but are not limited to, camera based systems, laser beam detection methods, and infrared and ultrasonic positioning devices.

In a preferred embodiment of the present invention, the surface 110 is a smooth, white, translucent whiteboard surface. The white surface provides the consumer with a familiar white-colored whiteboard. Additionally, the white surface is generally regarded as the best color to receive a display image, although other colors may be used. The white surface, likewise, is ideal for writing on the whiteboard (i.e. with a marker or stylus), or displaying display images. As one skilled in the art will recognize, many colors of the light spectrum can be used to implement the surface 110. As also described, the surface 110 can be translucent. The translucent characteristics of the surface 110 permits light to transmit through the surface 110 to reach the top sheet 112.

In a preferred embodiment of the invention, the top sheet 112 and the bottom sheet 116 are made of flexible polymer film onto which a layer of Indium Tin Oxide (ITO) can be applied. ITO-coated substrates are typically included in touch panel contacts, electrodes for liquid crystal displays (LCD), plasma displays, and anti-static window coatings. Usually, ITO is used to make translucent conductive coatings. In this embodiment, the top sheet 112 and the bottom sheet 116 can be coated with ITO and can, further, be translucent. In accordance with this embodiment, sheet 112 and 116 include ITO coatings. Alternatively, the top sheet 112 and the bottom sheet 116 can be coated with carbon. As one skilled in the art will appreciate, other translucent layers can be implemented with the top sheet 112 and bottom sheet 116 to provide additional desirable properties, such as improved service life, and the like.

Within the whiteboard 100, the bottom sheet 116 can be in communication with a foam cushion 120, or structural layer, then the metal backer 122, the rigid foam layer 125, and finally the second metal backer 126. The foam cushion 120, preferably, can be implemented with open cell foam. Open cell foam is foam in which cell walls are broken and air fills all of the spaces in the material. As one skilled in the art will appreciate, the foam cushion 120 may be implemented with many similar foam-like paddings. In particular, the metal backer 122, together with the rigid foam pad 125 and the second metal backing 126, can add stability to the whiteboard 100. Alternatively, the foam cushion 120 can be a layer or combination of layers that are rigid.

FIG. 3B depicts a side view of a particular layered embodiment of the present invention. Here, the surface 110 is positioned outward, i.e. to where the display image 250 would be projected. Behind the surface 110 is the top sheet 112. The surface 110 and the top sheet 112 can be composed of a single film with the desired properties on the surface 110. The surface 110 can also be a laminate or layering of multiple films, to achieve a combination of desired properties. Behind the top sheet 112 is the bottom sheet 116. Finally, behind the bottom sheet 116 are the foam cushion 120, the metal backer 122, the rigid foam pad 125 and the second metal backer 126, respectively. One skilled in the art will appreciate that the layering can be in another similar arrangement, perhaps with additional layer or with some layers removed, depending on the properties desired.

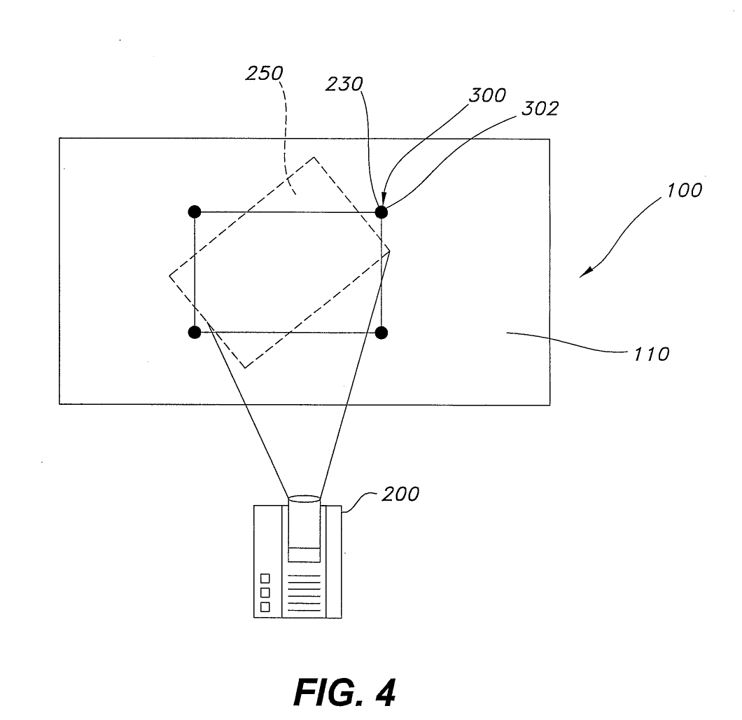

The projecting device 200 of the present system is illustrated in FIG. 4. As previously referenced, the projecting device 200 can be in communication with a personal computer. The projecting device 200 is casually aligned with the location sensitive surface 110. Because of this casual alignment, the relationship between the display video or image 250 and the surface 110 may not be known. Therefore, it is necessary to calibrate the image 250.

The electronic whiteboard 100 preferably includes a number of locations 230 with known coordinates, at which points sensors 302 are located. In an exemplary embodiment, four locations 230 are utilized. Additional locations 230 could be used depending on the size and shape of the whiteboard 100. Once the known locations 230 are determined, the coordinates can be stored, e.g. on computer 150, if there should be a blown circuit, a dysfunctional sensor, or a parts per million error with attached devices.

At each location 230, a sensor 302 of the sensor assembly 300 is used to measure a characteristic of the projected pattern 350. Preferably, the sensors 302 are optical sensors, and the characteristic is a measure of an intensity of optical energy from the projecting device 200 at the known locations 230 directly. This is in contrast with a camera based system that measures projected images indirectly after the images are reflected by the display surface. Alternatively, the sensors can receive of sound or audio.

The “direct” measurement of the light intensity or other characteristic has a number of advantages over “indirect” systems. For instance, unlike camera-based projector calibration, the present system does not have to deal with intensity measurements based on reflected light, which has a more complex geometry.

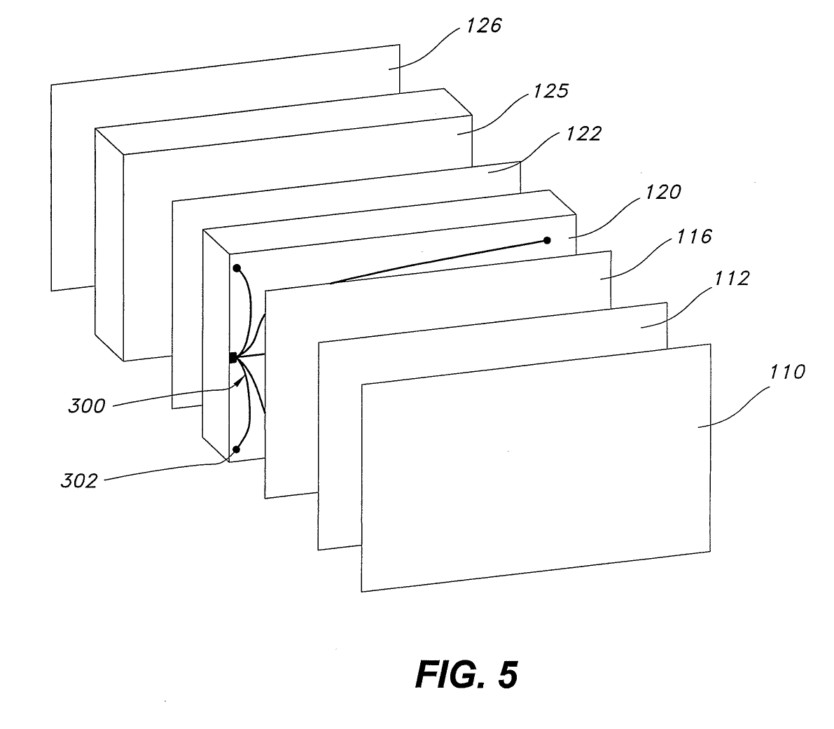

In the whiteboard illustrated in FIG. 5, the sensor assembly 300 comprises a plurality of sensors 302. In a particular embodiment, the sensors 302 can be photo sensors. The photo sensors can be photodiodes, phototransistors, or other optical detection devices mounted behind the bottom sheet 116 of the whiteboard 100.

In a preferred embodiment of the sensor assembly 300, a plurality of sensors 302 are placed behind the sheets—the top sheet 112 and the bottom sheet 116. Each sensor 302 is slightly depressed into the foam cushion 120. By having the sensor 302 depressed-into the foam cushion 120, the surface 110 and top sheet 112, remains flat, i.e. there are no bumps, ridges, or creases. Since the foam cushion 120 is in contact with the bottom sheet 116, top sheet 112, and the display surface 110, it is important to implement the sensors 302 in a way that would not interfere with potential writing on the display surface 110. As one skilled in the art should appreciate, the method of gently pushing the sensor 302 and their respective connections into the open cell foam is not the only method of guaranteeing a smooth outer surface. In another embodiment, the sensors 302 can be placed on the backside of bottom sheet 116; in this embodiment, the foam cushion 120 is optional and can be replaced by one or more spacers which support the bottom sheet around the sensors 302.

Alternatively, the photo sensors can be coupled to the locations by optical fibers. While the top surface including top sheet 112 and surface 110 can include through-holes to provide an optical path or a route for energy to strike the sensors, preferably the top sheet 112 and the bottom sheet 116 are translucent and no such holes are necessary.

If through-holes are necessary, each hole should be small enough that they are not perceived by the casual viewer. For example, the through-holes can be a millimeter in diameter, or less. It is well known how to make very thin optical fibers. This facilitates reducing a size of the sensed location to a size of projector pixels, or less. For the purpose of the invention, each sensed location corresponds substantially to a projected pixel in the output image. Further, there may be translucent areas of an opaque sheet or sheets; this area can include an optical hole.

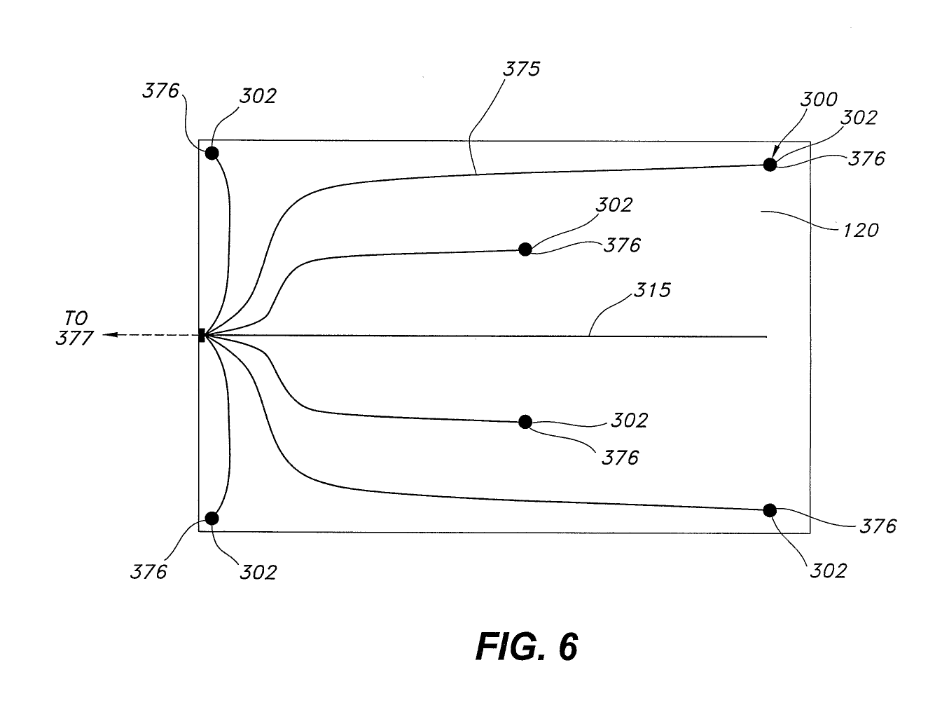

The sensors 302 can be arranged number of ways. FIG. 6 depicts one manner of positioning the sensor 302. In a particular embodiment, the sensor assembly 300 includes, typically, at least four sensors 302 in regions of the corners of the board. Preferably, a total of six sensors 302 or more are employed, which number can assist with keystone correction. As one skill in the art will appreciate, the more sensors implemented the more accurate the calibration can become. The sensors 302 can be placed at different locations about the board.

In a preferred embodiment, the sensors 302 are receiving ends of optical fibers 375, which fibers carry the receiving data to a photo sensor (e.g. the optical fiber is coupled to the photo sensor). The optical fiber 375 can be depressed-into the foam pad 120 gently to guarantee a smooth layer. The fiber 375, furthermore, can be coated with a light-blocking coating, preferably black India ink, to reduce the amount of leakage. For instance, the black India ink prohibits light flowing through the chamber of the optical fiber 375 and incident upon the length of the fiber, prohibiting leakage into the fiber 375.

In one embodiment of the present invention, the sensors 302 are not cut ends of fibers but are light emitting diodes (LEDs), or photodiodes, enabling the process of calibration to be reversed. That is, while in one mode the sensors 302 are designed to receive radiation of the projected pattern 350, which is measured and provides the proper alignment data; in another mode, the process is reversible, such that the LEDs give off radiation, preferably in the form of light, so the sensor locations 230 under a resistive top layer of the electronic whiteboard 100 can easily be seen and mapped if necessary, which is particularly helpful in a manufacturing environment. Additionally, the coordinates of the known locations 230 can be stored on a memory device for safe-keeping should damage occur to the whiteboard 100 or the whiteboard circuitry. The sensors 302 can be randomly arranged in the whiteboard 100, although the location of each is known precisely. An algorithm can be implemented to determine the random arrangement of the sensors 302, or other sensor locations to provide the optimal number of sensors, with optical placement, depending on, for example, whiteboard geometry. Upon operation of this algorithm the randomly placed sensors can be determined.

The substantially horizontal sensor 315, which is horizontal to the length of the whiteboard 100, can act as an overall detector to determine if the display image 250 is being projected onto the whiteboard 100. Generally, the sensor 315 can be used to determine whether light levels in proximity to the whiteboard have changed. Since the display image 250 may not fit the entire length and width of the whiteboard 100, the horizontal length sensor 315 can act to maximize detection of the display image 250 being present over a wide range of image sizes and orientations. In a particular embodiment, the horizontal length sensor 315 is an optical fiber. Moreover, the horizontal length fiber 315 is not coated or otherwise shielded as the signal it carries is light energy leaking through the side walls of the fiber.

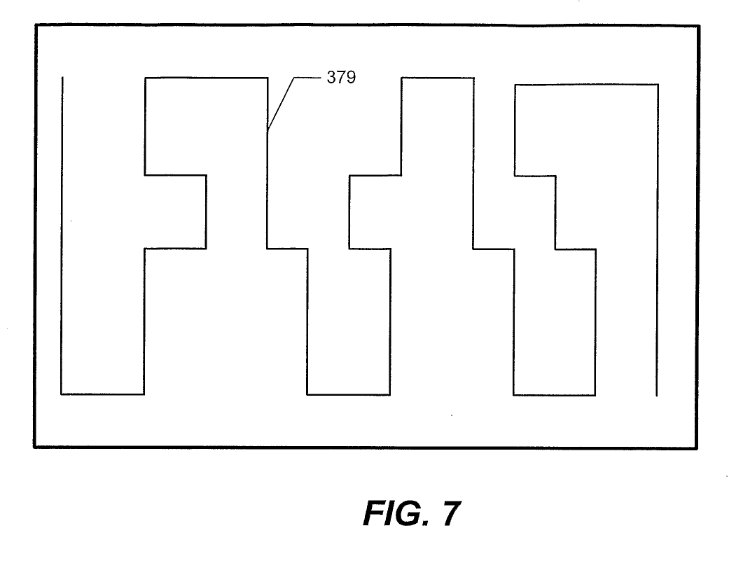

FIG. 7 illustrates an embodiment of the present invention having a single fiber, the fiber providing the whole of the sensor assembly. An optical fiber 379 can be placed within or on the whiteboard 100 as shown, or a similar arrangement. A single fiber embodiment permits light to leak into the fiber 379, since the entire fiber 379 is sensitive to light. This layout of fiber 379 is arranged to optically capture the projected pattern 350. As shown, the vertical portions of the fiber 379 have jogs. These jogs can be different from vertical run to vertical run. This arrangement enables the fiber 379 to resolve which of the vertical runs has light intensity upon it. On the other hand, the horizontal jogs, particularly in the center of the arrangement, can be sensing points for the vertical jogs. This assists projecting devices 200 that have electronic keystone correction capabilities. A benefit of this arrangement is it provides a low-cost solution, as it implements only one fiber 379, versus a multiple fiber/sensor solution.

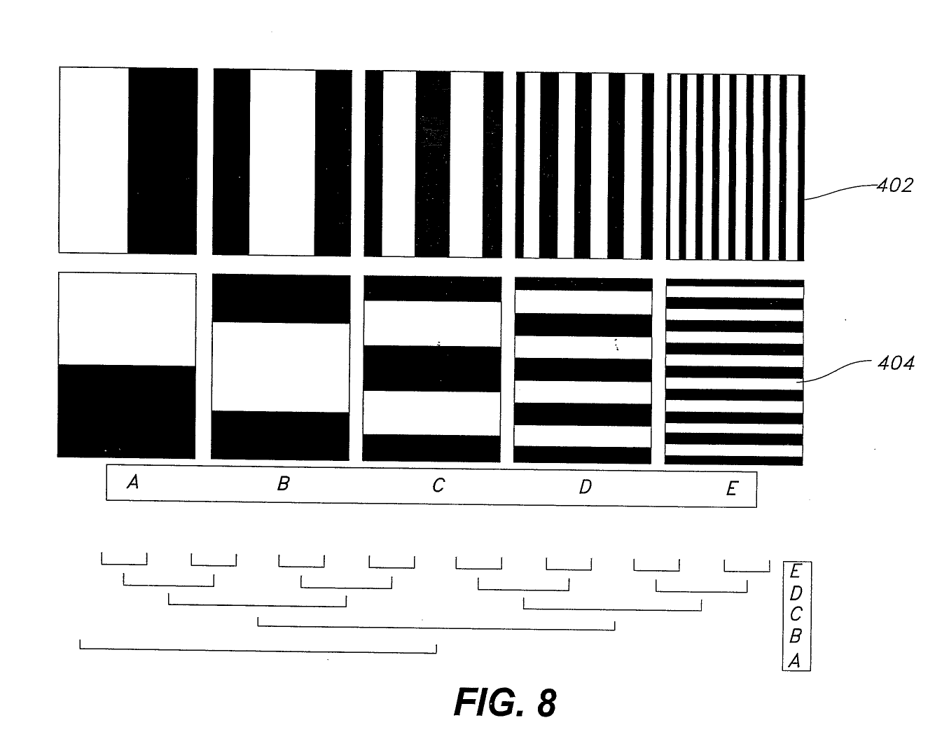

FIG. 8 illustrates a calibration module (processor) that can acquire sensor data from each of the sensors 302. In a preferred embodiment, the sensor data, after analog-to-digital (A/D) conversion, are quantized to zero and one bits in a digital representation of the amount of light present at each sensor. The projected light intensity can be thresholded against known ambient light levels to make this possible. As an advantage, these binary intensity readings are less sensitive to ambient background illumination. Although, it should be understood, that the intensity could be measured on a continuous scale. Links between the various components described herein can be wired or wireless. The calibration module can be in the form of a personal computer or laptop computer 150, or could be embedded within the whiteboard 100.

The calibration module can also generate and deliver a projected pattern 350. In an embodiment, the projected pattern 350 can be a set of calibration patterns 402 and 404 to the projecting device 200. The patterns are described in greater detail below. The calibration patterns 402 and 404 are projected onto the display surface 110 and the known locations 230 of the whiteboard 100.

A set of calibration patterns 402 and 404 can be projected sequentially. These patterns deliver a unique sequence of optical energies to the sensed locations 230. The sensors 302 acquire sensor data that are decoded to determine coordinate data of the locations 230 relative to the display image 250. The patterns can be light and dark patterns.

The preferred calibration patterns 402 and 404 are based on a series of binary coding masks described in U.S. Pat. No. 2,632,058 issued to Gray in March 1953. These are now known as “Gray codes.” Gray codes are frequently used in mechanical position encoders. As an advantage, Gray codes can detect a slight change in location, which only affects one bit. Using a conventional binary code, up to n bits could change, and slight misalignments between sensor elements could cause wildly incorrect readings. Gray codes do not have this problem. The first five levels, labeled A, B, C, D, E, show the relationship between each subsequent pattern with the previous one as the vertical space is divided more finely. The five levels are related with each of the five pairs of images (labeled A, B, C, D, E) on the right. Each pair of images shows how a coding scheme can be used to divide the horizontal axis and vertical axis of the image plane. This subdivision process continues until the size of each bit is less than a resolution of a projector pixel. It should be noted that other patterns can also be used, for example the pattern can be in the form of a Gray sinusoid.

When projected in a predetermined sequence, the calibration patterns 402 and 404 deliver a unique pattern of optical energy to each location 230. The patterns distinguish inter-pixel positioning of the locations 230, while requiring only [log₂(n)] patterns, where n is the width or height of the display image 250 in a number of pixels in the projected image.

The raw intensity values are converted to a sequence of binary digits corresponding to presence or absence of light [0,1] at each location for the set of patterns. The bit sequence is then decoded appropriately into horizontal and vertical coordinates of pixels in the output image corresponding to the coordinates of each location.

The number of calibration patterns is independent of the number of locations and their coordinates. The whiteboard 100 can include an arbitrary number of sensed locations. Because the sensed locations are fixed to the surface, the computations are greatly simplified. In fact, the entire calibration can be performed in several seconds or less.

Alternatively, the calibration pattern can be pairs of images, one followed immediately by its complementary negation or inverse, as in steganography, making the pattern effectively invisible to the human eye. This also has the advantage that the light intensity measurement can be differential to lessen the contribution of ambient background light.

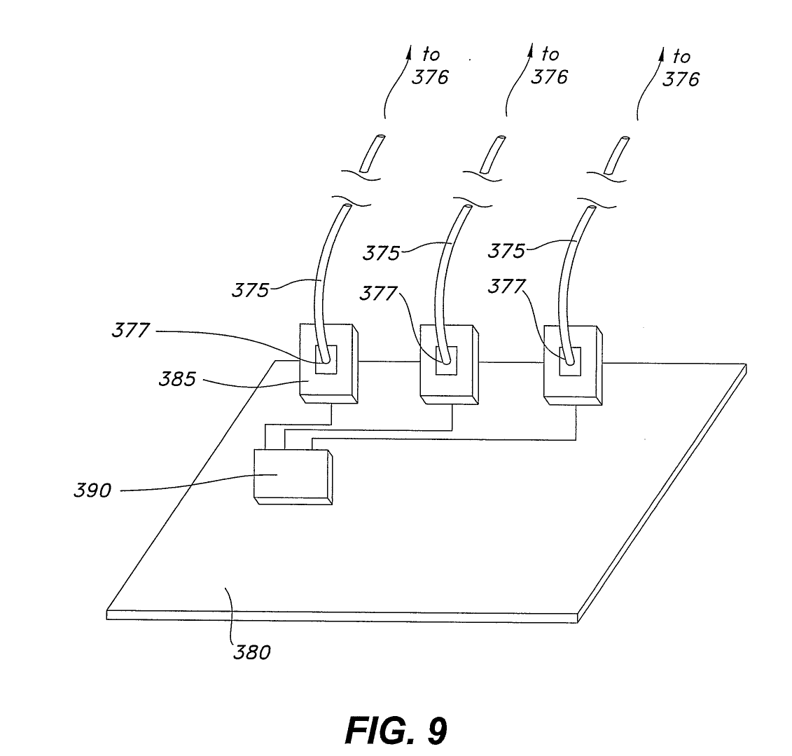

FIG. 9 depicts a preferred embodiment of the terminus of the sensor assembly 300, being a printed circuit board 380. The circuit board 380 in this embodiment is the connection point behind the sensor assembly 300/whiteboard 100, and the computer 150.

In a preferred embodiment, the whiteboard 100 includes a number of sheared optical fibers, the points of shearing being a particular sensor 302 at known location 230. The fibers thus begin at the receiving ends of fibers, at known locations 230, and end at the printed circuit board 380.

Either end of the optical fiber 375 can be treated to affect how it communicates light energy into the photo sensor 385. A preferred approach to treat the ends of the fibers 375 is to simply cut the end of the fiber 375 perpendicular to the length of the fiber 375. There are, however, other manners in which the ends of the fiber 375 can be terminated, as one skilled in the art will appreciate. Other manners include: sharpening the end to a point (similar to sharpening a pencil), attaching a prism to the end to reflect light to a particular entry point of the fiber, clipping the ends at an angle (i.e. approximately 45°), and adding a substance to the end to enlarge the end (e.g. a clear polymer), among others. These methods can improve the method of transmitting light from the end of the fiber 375.

Naturally, the fiber has two ends—the first end 376: ending at the known location 230; and the second end 377: ending at the printed circuit board 380. In a particular embodiment, the fiber 375 can be placed within the whiteboard 100. In this embodiment, the first end of the fiber 376 will be the known location 230 behind the sheets 112 and 116. The second end of the fiber 377 will be connected to the printed circuit board 380. The first end 376 within the whiteboard 100, can receive radiation, i.e. light, being displayed on the display surface 110. The light travels through the display surface 110. Then, it travels through the top sheet 112 and the bottom sheet 116. The light next meets the first end 376 of the fiber and is reflected within the fiber 375. Since the fiber 375 can allow additional light to leak in along the length of the fiber 375, coating the fiber 375 can minimize the amount of light entering this way. A preferred embodiment of coating the fiber 375 includes covering it substantially with black India ink, or a similar light-blocking substance. The first end 376 and the second end 377 of the fiber 375, obviously, are not coated, as they receive and transmit the light. As the light is reflected throughout the length of the fiber 375, the light eventually terminates at the printed circuit board 380, or the second end 377 of the fiber 375.

The printed circuit board 380 can have photo sensors 385, photo detectors, or other light sensing devices. The printed circuit board 380 can also include the circuitry necessary to run the electronic whiteboard 100. Alternatively, the circuitry may reside separate from the printed circuit board 380 that is connected to the photo sensors 385. The terminal ends of the fibers 375 are connected to the photo sensors 385. The photo sensor 385 can comprise a phototransistor, photodiode, or other light sensing device. The photo sensor 385 can determine the characteristics of the light passing through the fiber 375. Then, the photo sensor 385, which can be connected to a processor, can process the characteristics of the readings and provide a digital reading of the light intensity present at the far end of the fiber 375.

Additionally, an analog-to-digital (A/D) converter (not shown) can be used to perform more than one function. For instance, the same A/D converter can be used to do the fiber analog voltage detection and the touch location on the whiteboard.

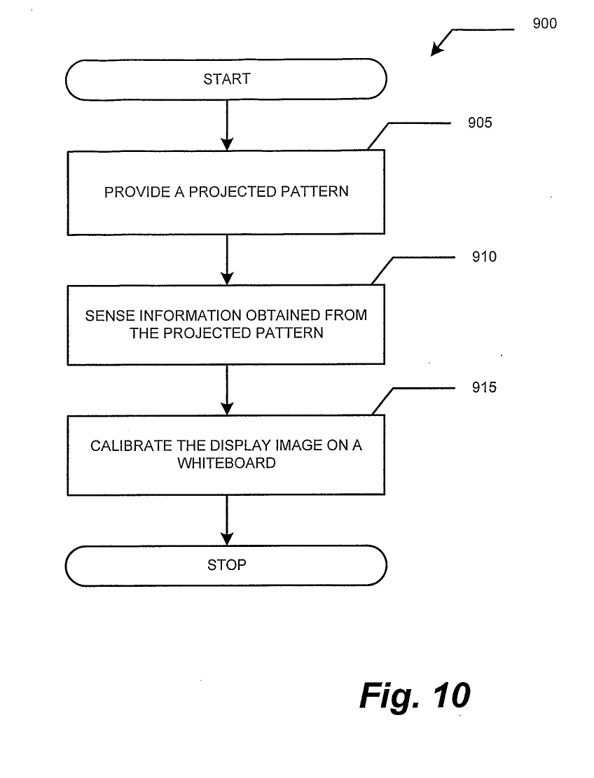

FIG. 10 depicts a logic flow diagram illustrating a routine 900 for calibrating the whiteboard 100. The routine 900 begins at 905, in which a projected pattern 350 is provided. The projected pattern 350 can include projecting an infra-red beam, displaying light and dark patterns, creating a noise of sound, or other forms of radiated energy.

The projecting device 200 can provide a projected pattern 350. The projected pattern 350 is projected generally toward the sensor assembly 300. The sensor assembly 300 senses the information obtained or received from the display. Based on the data or information obtained by the sensor assembly, the display image 250 projected from projecting device 200 is calibrated.

In one embodiment, the sensor assembly 300 can be implemented in such a way that some sensors 302 can be ignored. For instance, if light is not being received by a sensor 302, then it can be ignored and the rest of the sensor assembly 300 can be assessed.

In a particular embodiment, the sensor assembly 300 can be housed in or on the whiteboard 100. In this embodiment, the display image 250 can be projected directly upon the whiteboard surface 110 of the whiteboard 100 to be sensed.

In a particular embodiment, the sensor assembly 300 is housed within the whiteboard 100 and the display image 250 is projected by the projecting device 200. Consequently, the projecting device 200 projects a projected pattern 350 toward the whiteboard surface 110 of the whiteboard 100. The sensor assembly 300 senses information obtained from the pattern. The information is calculated and the characteristics of it are analyzed. The display image 250 is then properly calibrated on the whiteboard surface.

In one embodiment, there may be a time delay between the projecting device 200 and the signal sent from the processing device 150. For instance, this may exist in a wireless connection. This can be alleviated by capturing pixels of the display image 150. By evaluating the intensity of the pixel, in conjunction with the point in time at which the display image is transmitted, it can be assessed whether a time lag exists.

Next, at 910, the information obtained or gathered is sensed from the projecting display 200. The sensor assembly 300 handles this function. A sensor 302, which in a preferred embodiment comprises a photo sensor, senses the projected pattern 350.

Photo sensors automatically adjust the output level of electric current based on the amount of light detected. The Gray patterns, or projected pattern 350, can be projected to the surface 110 of the whiteboard 100. The first receiving end of the sensor 376, which can be located behind the bottom sheet 116 of the whiteboard 100, receives the intensity of the projected pattern 376. The projected pattern intensity is transmitted from the first end 376 of the fiber 375, through the fiber 375 to the second end 377 of the fiber 375. The projected pattern delivers a unique sequence of optical energies to the known location 230.

Since the second end 377 of the fiber 375 terminates into the photo sensor 385, which is connected to the printed circuit board 380, and the microcontroller 390, the characteristic of the pattern or sensor data, taken from the fiber 375 can be decoded. The sensor data are decoded to determine coordinate data of the known locations 230. The coordinate data are used to calibrate the location of the display image 250 on the whiteboard 100 and thus produce the calibrated display image 250. The coordinate data can also be used to compute a warping function; the warping function then is used to warp the image to produce the calibrated display image 250.

Finally, at 915, the display is calibrated on the whiteboard 100. The calibrated display image 250 is aligned with the display area on the surface 110 of the whiteboard 100.

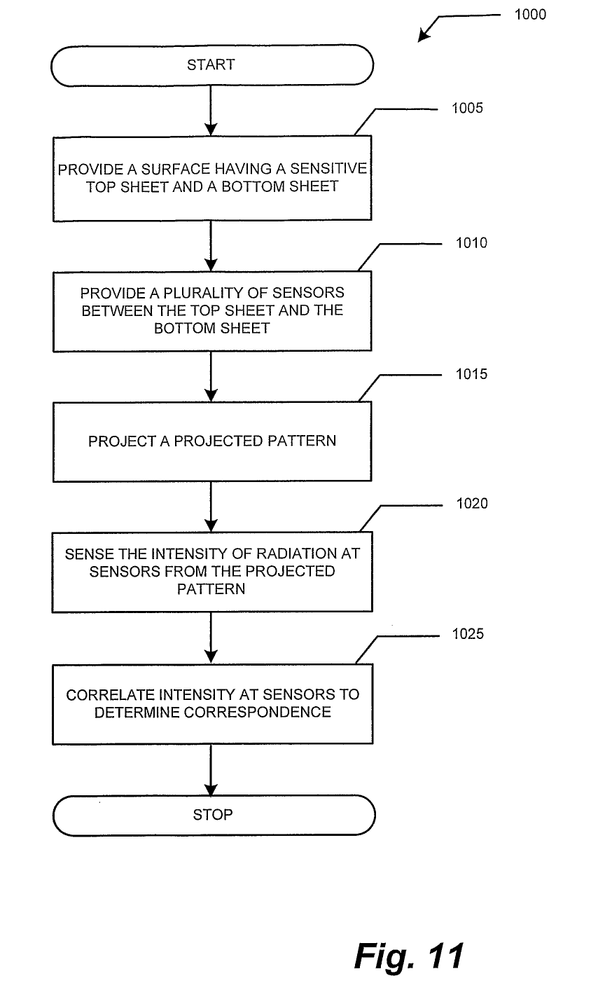

FIG. 11 depicts a logic flow diagram illustrating a routine 1000 for calibrating a whiteboard 100. Routine 1000 starts at 1005, in which a target surface is provided. The target surface can be a whiteboard 100, which can have a surface 110. The target surface can have a sensitive target surface. For instance, taking the whiteboard 100 as the target surface, the top sheet 112 and surface 110 act as the sensitive top surface, while the bottom sheet 116 acts as the bottom surface.

At 1010, a plurality of sensors 302 can be provided. The sensor 302 can be an optical sensor, photo sensor, photo transistor, photo diode, and the like. Furthermore, the sensor assembly can be positioned within or upon the whiteboard 100. In a preferred embodiment, the sensors 302 are positioned behind the top sheet 112 and bottom sheet 116. The sensors 302 can be hidden from view.

The sensors 302, additionally, can sample the frequency of room light or other potentially interfering energies. An interfering signal can be more effectively filtered over a time period that is a multiple of the interfering time period. A filter can be incorporated to reject the interfering signal, which can be accomplished by changing the integration time period. This sampling can help determine the frequency difference in light intensities sensed on the surface 110 of the whiteboard 100 and those throughout the room.

At 1015, a projected pattern 350 is projected from the projecting device 200. The projected pattern 350 can be a known pattern. The known pattern includes a Gray-code pattern. The pattern provides the necessary requisites to begin calibrating.

At 1020, the sensors 302 sense the intensity of the radiation for the projected pattern 350. As the projected pattern 350 is cycled, the sensors 300 recognize the light pattern and the connected microcontroller 390 begin to calculate the method of calibrating the image.

At 1025, the intensity at the sensors 302 is correlated to determine the correspondence required to calibrate. The intensity—light or dark, or black or white—corresponds to a binary number. For instance, if there is black light, a “0” is registered. Conversely, if there is a white light a “1” is registered. By calculating the binary numbers, the image can be calibrated since the sensors' locations are known and the amount of intensity that they should receive is also known. Upon having image calibrated, the process ends. The end of the calibration can be denoted by an audio tone.

While the invention has been disclosed in its preferred forms, it will be apparent to those skilled in the art that many modifications, additions, and deletions can be made therein without departing from the spirit and scope of the invention and its equivalents as set forth in the following claims.

1-16. (canceled)

17. In a calibration process for a tracking system comprising: (i) providing a tracking system having a presentation surface, (ii) providing a processor, (iii) providing a projecting device in communication with the processor, (iv) initiating the calibration process, (v) enabling the calibration process to proceed from initiation to completion by presenter interaction, and (vi) performing the calibration of positions between the presentation surface and the processor,
the improvement comprising enabling the calibration process to proceed from initiation to completion without presenter interaction.

18-58. (canceled)

59. A system for determining communication between locations on a presentation surface and pixels in a display image from a projecting device, the system comprising:
presentation surface comprising a plurality known locations;
projected pattern displayed by the projecting device; and
sensor assembly capable of sensing the intensity of light at a plurality of known locations on the presentation surface for the projected pattern;
wherein the intensity light from of the projected pattern calibrates the display image on the presentation surface.

60-65. (canceled)

66. A method of calibrating a tracking system of an interactive whiteboard system, the interactive whiteboard system including a computer and a whiteboard, the tracking system enabling commands at the whiteboard to be properly interpreted by the computer, such that a presenter can accurately control the computer from the whiteboard, the method comprising:
projecting a calibration pattern onto the whiteboard;
optically sensing at known locations of the whiteboard the projected calibration pattern; and
calibrating the computer and the whiteboard from the optically sensed projected calibration pattern.

67. The method of claim 66, wherein optically sensing at known locations of the whiteboard the projected calibration pattern is performed by sensors located behind the top surface of the whiteboard.

68. The method of claim 67, wherein each sensor comprises an optical fiber having a receiving end for optically sensing the projected calibration pattern.

69. The method of claim 68, wherein each optical fiber has a terminating end in communication with a photo sensor.

70. The method of claim 66, wherein the projecting calibration pattern is a pattern of light energy, being a combination of light and dark patterns.

71. The method of claim 66, wherein the projecting calibration pattern is a pattern of light energy, being a Gray scale pattern.

72. The method of claim 66, wherein calibrating the computer and the whiteboard is initiated automatically, without presenter direct intervention.

73. The method of claim 66, wherein calibrating the computer and the whiteboard occurs upon the interactive whiteboard system sensing the presenter entering the room having the whiteboard system.

74. The method of claim 73, wherein the automated sensing occurs when the lights of the room having the whiteboard system are turned on.

75. The method of claim 66, wherein completion of calibrating the computer and the whiteboard is indicated by an audio indicator.

76. A method of calibrating a tracking system of an electronic system, the electronic system including a processing device and a presentation surface, the tracking system enabling commands at the presentation surface to be properly interpreted by the processing device, such that a presenter can accurately control the processing device from the presentation surface, the method comprising:
providing a calibration pattern to the presentation surface;
sensing at known locations of the presentation surface the calibration pattern; and
calibrating the processing device and the presentation surface from the sensed calibration pattern,
wherein sensing at known locations of the presentation surface the calibration pattern is performed by sensors located behind the top surface of the presentation surface, and out of view of one viewing the presentation surface.

77. The method of claim 76, wherein each sensor comprises an optical fiber having a receiving end for optically sensing the calibration pattern, and a terminating end in communication with a photo sensor.

78. The method of claim 76, wherein the calibration pattern is a pattern of changing light and dark patterns upon the presentation surface.

79. The method of claim 78, wherein the calibration pattern is a Gray scale pattern.

80. The method of claim 76, wherein calibrating the computer and the whiteboard occurs upon automated sensing of the interactive whiteboard system of the presenter entering the room having the whiteboard system.

81. A method of calibrating an electronic display device, the method comprising:
receiving a pattern on at least a portion of a presentation surface of the electronic display device;
sensing a characteristic of the pattern on the presentation surface with a sensor assembly, wherein the sensor assembly is located behind the presentation surface of the electronic display device; and
synchronizing the presentation surface with a processing device to enable tracking between the presentation surface and the processing device.

82. The method of calibrating an electronic display device of claim 81, further comprising initiating the projected pattern to be received by the presentation surface of the electronic display device.

83. The method of calibrating an electronic display device of claim 81, further comprising displaying the image on the presentation surface of the electronic display device with a projecting device.

84. The method of calibrating an electronic display device of claim 81, wherein the electronic display device is an electronic whiteboard.

85. The method of calibrating an electronic display device of claim 81, further comprising verifying the characteristic between a location of a receiving end of the sensors and a pixel of the image to determine changes in the image.
